(19) United States
(12) Patent Application Publication
(10) Pub. No.: US 2014/0309328 A1
(43) Pub. Date: Oct. 16, 2014

(54) POLYMER FOR CONTACT LENSES

(71) Applicants: Rashid Abdul, Bellshill (GB); Neil Bonnette Graham, Bellshill (GB); Roderick Bowers, Bellshill (GB); Wade Tipton, Bellshill (GB); John Fraser, Bellshill (GB)

(72) Inventors: Rashid Abdul, Bellshill (GB); Neil Bonnette Graham, Bellshill (GB); Roderick Bowers, Bellshill (GB); Wade Tipton, Bellshill (GB); John Fraser, Bellshill (GB)

(73) Assignee: Ocutec Limited, Bellshill (GB)

(21) Appl. No.: 14/112,389

(22) PCT Filed: Apr. 19, 2012
(86) PCT No.: PCT/GB2012/000390

§ 371 Date: Apr. 25, 2014

(30) Foreign Application Priority Data
Apr. 21, 2011 (GB) 1106778.2

(51) Int. Cl. G02B 1/04; B29D 11/00; C08G 18/66

(52) U.S. Cl. CPC G02B 1/043; C08G 18/6666; B29D 11/00067
USPC 523/106; 528/76; 264/1.36

(57) ABSTRACT

The present invention relates to polyurethane polymer compositions prepared by reacting a mixture comprising: a) at least one poly(ethylene glycol), b) at least one polyoxyalkylene diol (typically PPG or a copolymer of ethylene oxide and propylene oxide), c) at least one di- or poly-isocyanate, d) at least one polyol or macropolyol having a functionality greater than 2, or a mixture of such polyols or macropolyols having a functionality greater than 2, e) optionally an additional compound comprising at least one hydroxyl group and at least one primary or secondary amine group. The present invention also relates to an article comprising such a polymer, in particular a medical device such as a contact lens. A process for preparing a polyurethane hydrogel is also provided.

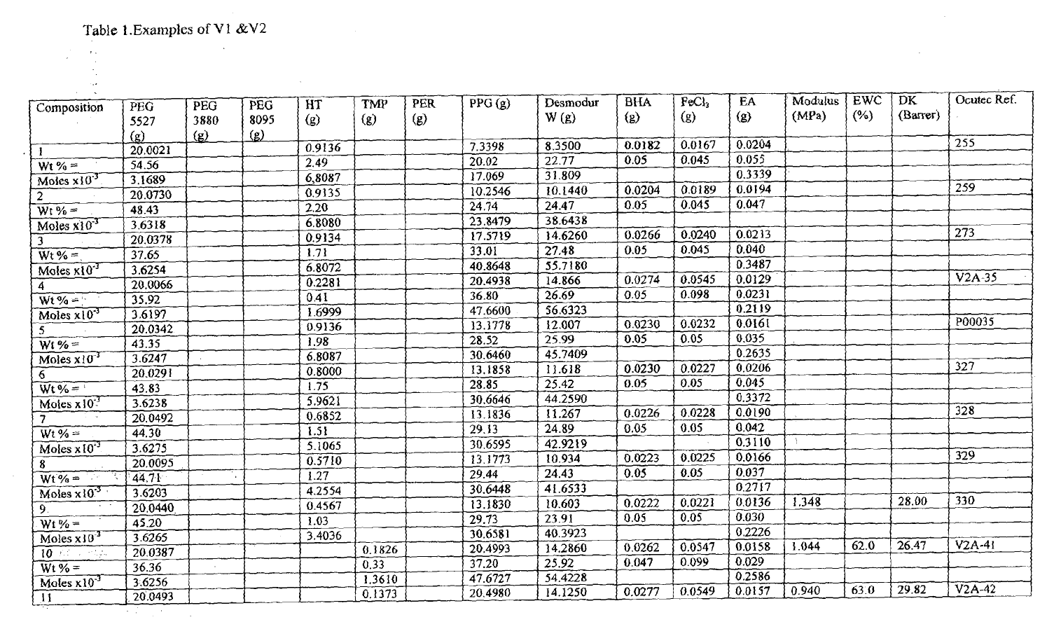

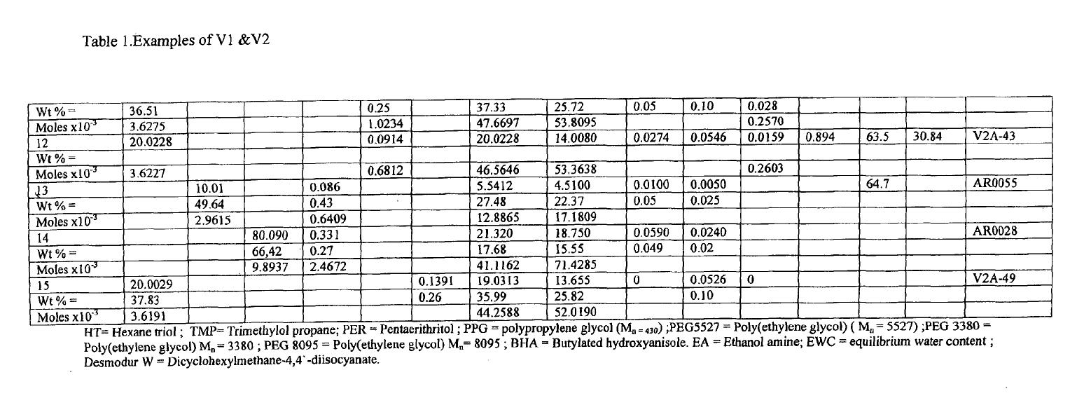

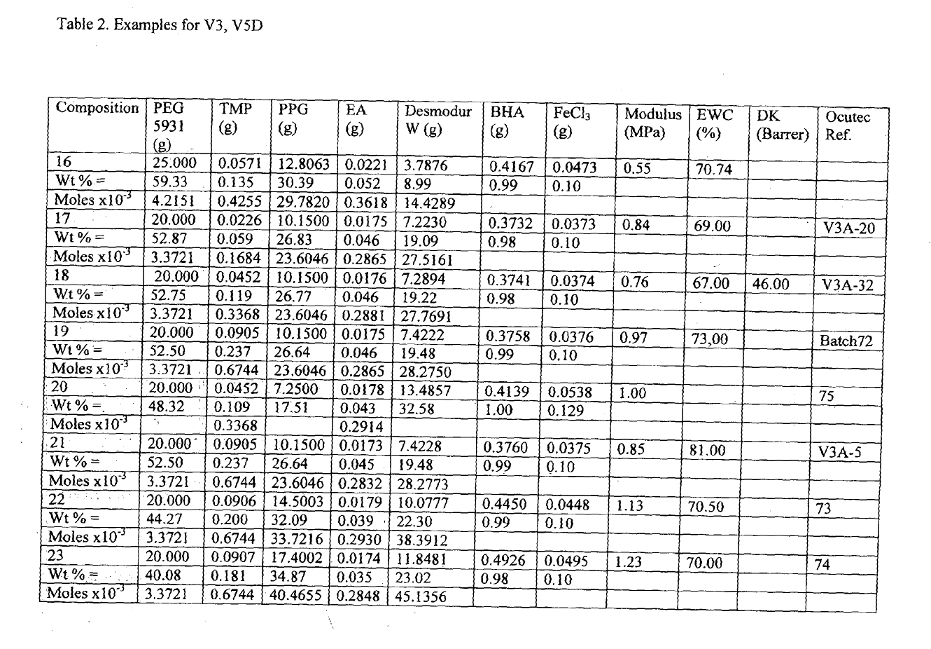

The present invention relates to poly(ethylene glycol), PEG based polyurethane polymers that have applications in the field of contact lens technology. The invention also relates to a process for preparing such materials, which can desirably and preferably be prepared in the complete absence of solvents.

### BACKGROUND TO THE INVENTION

Soft contact lenses offer a viable alternative to spectacles for the correction of visual defects such as myopia, hypermetropia and astigmatism. Early hydrogel lenses are derived almost exclusively from hydrophilic monomers such as 2-hydroxyethyl methacrylate (HEMA). Although these lenses provided some comfort, they did not provide sufficient oxygen permeability to prevent problems associated with corneal hypoxia. Attempts to address this problem included copolymerising HEMA with hydrophilic monomers such as methacrylic acid and N-vinyl pyrrolidone. Although these polymers increased the level of oxygen permeability, the incorporation of these comonomers also leads to problems such as protein and lipid deposition, corneal desiccation, staining and lens dehydration.

More recently, a new generation of polymers has been developed to further increase the level of oxygen. These materials are based on the copolymerisation of silicone methacylates with hydrophilic comonomers. The lenses produced from these materials were originally designed for extended wear, though daily wear products also exist now. Although successful in further increasing the oxygen permeability, these new materials still suffer from limitations such as lipid binding and dryness, all of which decrease lens on eye comfort.

There is therefore still a need for new contact lens polymers, which offer sufficient oxygen levels for normal corneal metabolism during daily wear and for extended wear, and which provide a high level of comfort throughout the day.

One class of polymers which holds considerable promise for novel contact lens materials are PEG based polyurethanes.

Urethane chemistries have also been widely investigated in the field of biomedical devices. For example, U.S. Pat. No. 3,786,034 discloses hard, hydrophilic polyurethane materials formed from reacting a specific polyol with a polyfunctional isocyanate. U.S. Pat. No. 3,821,186 teaches similar such materials. Likewise, U.S. Pat. No. 4,136,250 teaches a polymer formed by reacting a high molecular weight polydimethyl siloxane diol with 2 mole equivalents of isophorone di-isocyanate and then reacting with excess hydroxyl-containing monomers. Further urethane copolymers are disclosed in U.S. Pat. No. 4,454,309 and U.S. Pat. No. 4,359,553.

U.S. Pat. No. 6,930,196 discloses polyurethane hydrogel contact lenses prepared from prepolymers made by reacting (a) at least one multifunctional compound; (b) at least one di-isocyanate; and (c) at least one diol. The prepolymers so formed are then reacted with excess water to form a hydrogel polymer suitable for use as a contact lens.

U.S. Pat. No. 4,644,033 discloses a polyurethane hydrogel formed from the reaction of a polyoxyethylene and a polyfunctional isocyanate in a non-aqueous solvent. The materials can be molded into contact lenses.

U.S. Pat. No. 5,932,200 discloses polyurethane formed from reacting a diol component and an organic di-isocyanate with critical selection of the amount of water in the reaction mixture and the diol component. The polyurethane is in the form of a gel that has applications in burn/wound care dressings and as surgical implants.

U.S. Pat. No. 4,885,966 and U.S. Pat. No. 5,175,229 disclose hydrophilic polymeric soft contact lenses prepared from prepolymers that are isocyanate-capped oxyethylene-based diols or polyols having a molecular weight of about 7000 to 30,000, wherein essentially all of the OH groups are capped with isocyanate. The prepolymers are hydrated to form polyurea-polyurethane polymers that are characterised by having a non-ionic surface which is resistant to non-specific protein adsorption.

It is well known anecdotally that poly(ethylene glycol) based polyurethane copolymers are associated with poor storage stability. Known poly(ethylene glycol) based polyurethanes generally do not consistently maintain their properties after 6 months storage. The stability of polymers forming medical devices is clearly paramount. The properties of materials used in the manufacture of medical devices must be maintained upon extended periods of storage. The properties of such materials must be predictable and consistent. Materials having low and/or inconsistent storage stability are not suitable for use in the manufacture of medical devices such as contact lenses, regardless of any other promising properties.

The present invention seeks to provide new polyoxyethylene based polyurethane-based materials that are suitable for use in the contact lens industry. Ideally, the polyoxyethylene polyurethane-based materials of the invention exhibit exemplary physical properties. According to a first aspect of the present invention there is provided a polyurethane polymer composition prepared by reacting a mixture comprising:
a) at least one poly(ethylene glycol),
b) at least one polyoxyalkylene diol (typically PPG or a copolymer of ethylene oxide and propylene oxide),
c) at least one di- or poly-isocyanate,
d) at least one polyol or macropolyol having a functionality greater than 2, or a mixture of such polyols or macropolyols having a functionality of greater than 2,
e) optionally an additional compound comprising at least one hydroxyl group and at least one primary or secondary amine group.

According to a second aspect of the present invention there is provided a process for preparing a polyurethane hydrogel, said process comprising:
i. preparing a mixture of:
   a) at least one poly(ethylene glycol),
   b) at least one polyoxyalkylene diol (typically PPG or a copolymer of ethylene oxide and propylene oxide),
   c) at least one di- or poly-isocyanate,
   d) at least one polyol or macropolyol having a functionality greater than 2, or a mixture of such polyols or macropolyols having a functionality of greater than 2, and
   e) optionally an additional compound comprising at least one hydroxyl group and at least one primary or secondary amine group;
ii. allowing the mixture formed in step i) to react appropriately to form a cross-linked polyurethane xerogel;
iii. hydrating the xerogel using an aqueous medium to form a hydrogel.

A third aspect of the invention relates to a polymer obtainable by the above described process.

A fourth aspect of the present invention relates to a process for preparing a contact lens comprising the steps of:
i) preparing a mixture of:
   a. at least one poly(ethylene glycol),
   b. at least one polyoxyalkylene diol (typically PPG or a copolymer of ethylene oxide and propylene oxide),
   c. at least one di- or poly-isocyanate, and
   d. at least one polyol or macropolyol, said macropolyol having a functionality greater than 2, or a mixture of such polyols or macropolyols having a functionality of greater than 2 and,
   e. optionally an additional compound comprising at least one hydroxyl group and at least one primary or secondary amine group;
ii) dispensing the reaction mixture formed in step i) into a contact lens mold;
iii) allowing the reaction mixture to react and cure (generally with the assistance with energy, in particular thermal energy or other means of radiation);
iv) removing the contact lens from the mold; and
v) hydrating the contact lens, optionally in the presence of a surface active agent, such as a polysorbate compound or poloxamer or mixture thereof.

A fifth aspect of the present invention relates to an article of manufacture comprising a polymer as described above.

A sixth aspect of the present invention relates to the use of a polymer as described above in the preparation of a contact lens.

### DEFINITIONS

“Polyfunctional” is generally used to refer to a molecule, or a mixture of molecules having more than 2 functional groups that are capable of reacting in the system.

The di-isocyanate has a functionality of two, the poly-isocyanate has a functionality of greater than two where the “functionality” refers to the number of NCO groups present in the di- or poly-isocyanate compound.

The “cross-linking compound” provides additional covalent bonds between polyurethane chains. Generally the cross-linking agent reacts with the NCO groups of the di- or poly-isocyanate.

“DK” is a measure of the oxygen permeability of a material provided in Barrer units where 1 Barrer=10⁻¹¹ cm²·ml·mmHg.

The term “tertiary hydrogen atom” is used to refer to a hydrogen atom attached to a carbon atom having three substituents other than hydrogen where one of the three substituents is oxygen.

The term “hydrogel” is used herein to refer to a polymer comprising 10 wt % or more water. A hydrogel in an aqueous medium will absorb water and retain its original dry shape but it will be enlarged. It will not dissolve in water to form a fluid solution unless it is significantly degraded.

The term “xerogel” is used herein to refer to a polymeric material which may form a hydrogel upon contact with sufficient water. Generally a xerogel is dry and comprises less than 5 wt % water.

The term “substantially anhydrous” is used herein to refer to conditions in which the amount of water is sufficiently low so as to produce a polyurethane backbone that is substantially free from urea groups. Preferably the amount of water in the reactant mixture is less than about 0.3 wt. %, more preferably less than about 0.1 wt. %, even more preferably less than about 0.05 wt. %.

Polyol is referred herein as a compound having more than 2 available hydroxyl groups. Polyols generally have a molecular weight less than or equal to 1000.

Macropolyol is generally used to refer to a compound having more than 2 available hydroxyl groups linked to polyoxyethylene and/or polyoxypropylene homo or copolymer and generally has a molecular weight greater than 1000.

“RCM” or “reaction cast molding” is used to refer to molding techniques which involve the steps of mixing the reactants together, dispensing the reactant mixture into a mold and allowing the reactant mixture to react and cure (generally with the assistance of energy, in particular thermal energy or radiation).

The term “chain extender” is typically used to refer to a low molecular weight difunctional monomer (typically but not exclusively of the order of 1000 gmol⁻¹

### Polymer Composition

As noted above, the present invention provides a polyurethane polymer composition prepared by reacting a mixture comprising:
a) at least one poly(ethylene glycol),
b) at least one polyoxyalkylene diol (typically PPG or a copolymer of ethylene oxide and propylene oxide),
c) at least one di- or poly-isocyanate,
d) at least one polyol or macropolyol having a functionality greater than 2, or a mixture of polyols having a functionality of greater than 2,
e) optionally an additional compound containing at least one hydroxyl group and at least one primary or secondary amine group.

It is well known anecdotally that PEG based polymers substantially fail because of poor storage stability. No solution to this problem has currently been proposed. This has resulted in the lack of commercialisation of PEG polymer contact lenses which have other very promising qualities (previously reported in patents such as U.S. Pat. No. 6,930,196). The present invention provides an effective solution to the stability problem, and represents a major contribution to the knowledge in the art towards utilising PEG composition in the field of contact lenses.

According to a further aspect of the present invention there is provided a contact lens formed from the polymer composition. The properties of such a contact lens are extremely promising.

Contact lenses formed from the polymer of the present invention generally have a water content of 50 to 70 wt %, typically around 60 wt %, and this is considered desirable in terms of the industry standard. The oxygen permeability of contact lenses formed from the polymer of the present invention is generally at least as high, or higher than most hydrogel contact lenses. The DK value of the polymer of the present invention is typically 20 to 40 Barrer, generally 25 to 35 Barrer, suitably around 30 Barrer. The tensile properties of the lenses are also good, with the modulus typically 0.4 to 0.6 MPa, generally around 0.5 MPa.

### Poly(Ethylene Glycol)

The present invention involves the use of at least one poly(ethylene glycol) (PEG). The PEG is preferably a pharmaceutical grade poly(ethylene glycol) with a molecular weight of approximately as described below. PEG is a main functional constituent of the composition of the present invention. In addition, PEG also plays a key role in controlling the hydrophilicity (affinity for water) of the surface of the composition of the present invention and items formed therefrom (in particular medical devices such as contact lenses), which in turn governs the biocompatibility of the resultant composition and items formed therefrom with biological tissue and fluids.

Suitably the PEG has a molecular weight of about 200 to about 30,000, more suitably from about 500 to about 20,000, typically 2000 to 12000, generally 2000 to 10000, preferably 3000 to 9000, advantageously 2000 to 8000.

According to one embodiment the PEG compound has a molecular weight of about 3000 to about 7000. According to one aspect of the present invention the PEG has a molecular weight of 5000 to 6000, suitably 5500 to 6000. Preferably the PEG compound has a molecular weight of around 5527+/−250, or around 3880+/−250.

In one preferred embodiment, the PEG is PEG 6000 (where the numbers represent the number average molecular weight).

According to one embodiment of the present invention, all PEG compounds used to form the composition of the present invention have a molecular weight of 5000 to 6000, suitably 5500 to 6000.

Alternatively, the composition of the present invention may include a PEG compound as described above and a second PEG compound which may have a molecular weight higher or lower than that described above, typically a second PEG compound having a molecular weight lower than that described above.

According to a further embodiment of the present invention, the composition comprises a first low molecular weight PEG compound (LMW PEG) and a second high molecular weight PEG compound (HMW PEG). Suitably the LMW PEG has molecular weight less than 4500, typically from about 3000 to about 4000, generally 3500 to 4000. Suitably the HMW PEG has molecular weight greater than 7000, typically from about 7500 to about 8500, generally 8000 to 8500. According to one embodiment, the composition comprises a LMW PEG compound having a molecular weight of 3500 to 4000 and a HMW PEG compound having a molecular weight of 8000 to 8500. Preferably the HMW PEG compound has a molecular weight of 8095+/−250.

Preferably, the reactant mixture comprises from about 10 to about 95 wt % PEG, typically from about 30 to about 70 wt % PEG.

According to one embodiment the reactant mixture comprises from about 10 to about 95 wt % PEG having a molecular weight of 3000 to 9000, generally 4000 to 7000, typically from about 30 to about 70 wt % PEG having a molecular weight of 4000 to 7000.

Alternatively or additionally the reactant mixture may comprise from about 10 to about 95 wt % PEG having a molecular weight of 4500 or less, typically from about 30 to about 70 wt % PEG having a molecular weight of 4500 or less.

According to one embodiment, the reactant mixture may comprise 30 to 70 wt % of a first PEG compound having a molecular weight of 4500 or less and 30 to 70 wt % of a second PEG compound having a molecular weight of 7000 or more.

According to one embodiment of the present invention, the second PEG is selected from the group consisting of PEG 6000, PEG 3500 and PEG 8000 (where the numbers represent the number average molecular weight).

### Polyoxyalkylene Diol

The polyoxyalkylene diol used to form the composition of the present invention is generally poly(propylene glycol) (PPG) of which one of the many possible structures is given below.

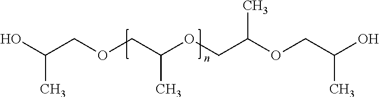

n=1-20, more preferably 4-10 even more preferably 4-5

### PPG

Poly(propylene glycol) (PPG) is a colourless, viscous liquid. The main function of PPG is to dictate the mechanical properties of the lens and is used to provide the right stiffness (modulus) and tensile properties so that the contact lens can be handled by the patient and the lens will be comfortable to wear. Accordingly, increasing the proportion of PPG in the reactant mixture increases the modulus of the resultant composition. If the modulus of the resultant composition is too high, an article formed therefrom will be uncomfortable to wear and the risk of infection will be increased. If the modulus of the resultant composition is too low, an article formed from the resultant composition will be associated with poor storage stability and poor handlability. The proportion of polyoxyalkylene diol must be controlled to ensure that the properties of the resultant composition are acceptable.

Alternatively, the polyoxyalkylene diol may be a copolymer of ethylene oxide and propylene oxide, generally comprising terminal hydroxyl groups. According to one embodiment, the polyoxyalkylene diol is a copolymer of poly(ethylene glycol) and poly(propylene glycol), generally comprising terminal hydroxyl groups.

Typically the reactant mixture comprises from about 10 to about 70 wt % polyoxyalkylene diol, generally from about 30 to about 70 wt % polyoxyalkylene diol.

Generally the polyoxyalkylene diol is PPG having a molecular weight of 300-1200 or in some embodiments even more than this. Typically, the polyoxyalkylene diol has a molecular weight of 400-1200, suitably 300 to 800, preferably 400-500. In one embodiment the molecular weight is around 430.

### Di- or Poly-Isocyanate

The polymer composition of the invention is prepared using at least one di- or poly-isocyanate. Preferably, the di- or poly-Isocyanate is an aliphatic di- or poly-isocyanate. The main function of the di- or poly-isocyanate is to initiate and propagate the polymerisation reaction by reacting with hydroxyl groups of PEG and PPG, as well as the polyols/macropolyols and optionally the additional compound.

Where a poly-isocyanate is used, it has a functionality of greater than 2, generally 3, 4 or 5, advantageously 3 or 4. Where a poly-isocyanate is used, the use of a polyol may become optional as the poly-isocyanate may provide the degree of crosslinking equivalent to that of the polyol in the composition. However combination of both the polyol and poly-isocyanate may also be used to obtain the optimal extent of crosslinking required for an article formed from the polymer of the present invention, in particular an article such as a contact lens.

Suitable poly-isocyanates for use in the compositions of the present invention include, tri-functional trimer (isocyanurate) of isophorone diisocyanate, trifunctional trimer (isocyanurate) of hexamethylene diisocyanate and polymeric 4,4′-diphenylmethane diisocyanate.

More preferably, the di- or poly-isocyanate is aliphatic and is free from aromatic units.

Preferably, the di- or poly-isocyanate is liquid at ambient temperature.

In one preferred embodiment, the polymer composition of the invention is prepared using at least one di-isocyanate.

Preferably, the di-isocyanate is of the formula OCN—R₁—NCO, wherein R₁ is a linear or branched C₂-C₁₈-alkylene, an unsubstituted or C₁-C₄-alkyl-substituted or C₁-C₄-alkoxy-substituted C₆-C₁₀-arylene, a C₇-C₁₈-aralkylene, a C₆-C₁₀-arylene-C₁-C₂-alkylene-C₆-C₁₀-arylene, a C₃-C₈-cycloalkylene, a C₃-C₈-cycloalkylene-C₁-C₆-alkylene, a C₃-C₈-cycloalkylene-C₁-C₆-alkylene-C₃-C₈-cycloalkylene or a C₁-C₆-alkylene-C₃-C₈-cycloalkylene-C₁-C₆-alkylene.

Examples of suitable di-isocyanates and preferred di-isocyanates include methylene dicyclohexyl diisocyanate, isophorone diisocyanate, toluene-2,4 diisocyanate, toluene-2,6-diisocyanate, mixtures of toluene-2,4 and 2,6-diisocyanates, ethylene diisocyanate, ethylidene diisocyanate, propylene-1,2-diisocyanate, cyclohexylene-1,2-diisocyanate, cyclohexylene-1,4-diisocyanate, m-phenylene diisocyanate, 4,4″-biphenylene diisocyanate, 3,3″-dichloro-4,4″-biphenylene diisocyanate, 3,3″; -diphenyl-4,4″; -biphenylene diisocyanate, 1,6-hexamethylene diisocyanate, m-phenylene diisocyanate 1,4-tetramethylene diisocyanate, 1,10-decamethylene diisocyanate, cumene-2,4-diisocyanate, 1,5-napthalene diisocyanate, 1,4-cyclohexylene diisocyanate, 2,5-fluorenediisocyanate, polymeric 4,4′-diphenylmethane diisocyanate. p-tetramethyl xylylene diisocyanate, p-phenylene diisocyante, 4-methoxy-1,3-phenylene diisocyante, 4-chloro-1,3-phenylene diisocyanate, 4-bromo-1,3-phenylene diisocyanate, 4-ethoxy-1,3-phenylene diisocyanate, 2,4-dimethyl-1,3-phenylene diisocyanate, 5,6-dimethyl-1,3-phenylene diisocyanate, 2,4-diisocyanatodiphenylether, 4,4″-diisocyanatodiphenylether, benzidine diisocyanate, 4,6-dimethyl-1,3-phenylene diisocyanate, 9,10-anthracene diisocyanate, 4,4′-dlisocyanatodibenzyl, 3,3′-dimethyl-4,4′-diisocyanatodiphenylmethane, 2,6-dimethyl-4,4′-diisocyanatodiphenyl, 2,4-diisocyanatostilbene, 3,3′-dimethoxy-4,4′-diisocyanatodiphenyl, 1,4-anthracenediisocyanate, 2,5-fluorenediisocyanate, 1,8-naphthalene diisocyanate, 2,6-diisocyanatobenzfuran, xylene diisocyanate, m-tetramethyl xylylene diisocyanate or methylene dicyclohexyl diisocyanate.

The di-isocyanate is preferably an aliphatic di-isocyanate. Aliphatic di-isocyanates which are fluid at ambient temperatures are particularly preferred.

In one highly preferred embodiment, the diisocyanate is Desmodur W (methylene bis(4,4′cyclohexyl isocyanate), molecular weight, MW=around 262.5).

Preferably, the di- or poly-isocyanate is used in an amount of from about 9 wt % to about 50 wt % of the reaction mixture, more preferably from about 20 wt % to about 35 wt %. The amount of di- or poly-isocyanate in any given composition can be adjusted to modify the relevant contact lens properties/attributes.

### Polyol/Macropolyol

The reactant mixture used to form the composition of the present invention comprises at least one polyol or macropolyol having a functionality of more than two, or a mixture of such polyols or macropolyols having an average functionality of greater than 2.

According to some embodiments of the present invention, the polyol/macropolyol may comprise tertiary hydrogen atoms (in particular, where the polyol is glycerol). Generally, where the polyols of the present invention comprise tertiary hydrogen atoms, they have only one tertiary hydrogen atom per molecule.

The hydroxyl groups of the polyol/macropolyol and the PEG compound react with the NCO groups of the di- or poly-isocyanate to form a polymer matrix. The proportion/concentration of the polyol/macropolyol used in the reactant mixture affects the resultant material properties of the polyurethane composition formed. In particular, in cases where there is enough isocyanate to react with all of the hydroxyl groups, the greater the concentration of any given polyol/macropolyol in the reactant mixture, the greater the degree of cross-linking, leading to an increased modulus of the polyurethane composition formed. The amount of polyol/macropolyol used depends on the extent of cross-link density required, and the resultant tensile properties required. Increasing the concentration of polyol/macropolyol increases the modulus and reduces the water content of the resultant composition. Generally the reaction mixture of the present invention comprises 10 wt % or less polyol or macropolyol, typically 7 wt % or less, suitably 5 wt % or less.

The polyol or macropolyol, di- or poly-isocyanate, polyoxyalkylene diol, PEG (and optionally the additional compound) react to eventually form a polymer matrix.

According to one embodiment, the polyol has the structure of formula I:

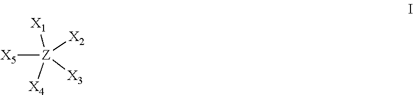

wherein at least three of X₁, X₂, X₃, X₄ and X₅ each independently comprise a terminal hydroxyl group with the remainder of X₁, X₂, X₃, X₄ and X₅ being independently H or absent, and Z is a central linking unit.

The polyol is a moiety comprising initiating hydroxyl groups attached to a central linking group, which is generally essentially hydrocarbon. These hydroxyl groups can each be used to polymerise a polyalkyleneoxide chain terminated by a hydroxyl group. The finally produced central linking moiety Z is generally devoid of active hydrogen atoms, that is hydrogen atoms which can initiate polymerisation. Z may contain groups that are inert to reaction with NCO groups or the alkylene oxides which are being polymerised or copolymerised. Generally the Z group has a molecular weight of 1000 or less.

Generally, at least three of X₁, X₂, X₃, X₄ and X₅ are each independently an OH-terminated polyoxyalkylene chain, preferably OH-terminated polyoxyethylene or polyoxypropylene chains.

The polyol of formula I is preferably a macropolyol. As used herein, the term “macropolyol” refers to a macromer bearing multiple OH groups.

As used herein, the term “macromer” (also referred to as “macromonomer”) refers to a polymer or oligomer that has a functional group capable of participating in further polymerisation.

Generally 3, 4 or 5 of X₁, X₂, X₃, X₄ and X₅ comprise a terminal hydroxyl group.

According to one embodiment one or more of X₁, X₂, X₃, X₄ and X₅ independently represents a hydroxyl group or an OH terminated, optionally substituted, polyoxyalkylene chain. Typically 3, 4 or 5 of X₁, X₂, X₃, X₄ and X₅ independently represent a hydroxyl group or an OH terminated, optionally substituted, polyoxyalkylene chain.

Typically the polyoxyalkylene chain comprises up to 6 carbon atoms; generally the polyoxyalkylene chain comprises up to 3 carbon atoms.

The polyoxyalkylene chain may be substituted with one or more ether groups. According to one embodiment the polyoxyalkylene chain is not substituted.

One or more of X₁, X₂, X₃, X₄ and X₅ may independently represent an OH-terminated polyoxyalkylene chain wherein the polyoxyalkylene chain preferably does not comprise any tertiary hydrogen atoms. In particular 3, 4 or 5 of X₁, X₂, X₃, X₄ and X₅ may independently represent an OH-terminated polyoxyalkylene chain. Preferably, the polyoxyalkylene chains are polymers and/or co polymers of ethylene oxide and/or propylene oxide in which the terminal hydroxyl groups may be primary or secondary hydroxyls, or a mixture thereof. More preferably, the polyoxyalkylene chains are OH-terminated polyoxyalkylene chains selected from polyoxyethylene and polyoxypropylene units or a mixture thereof. However copolymers of ethylene oxide and propylene oxide can also be used. Generally such copolymers comprise terminal hydroxyl groups.

Where the polyol of formula I is derived from the polymerization of ethylene or propylene oxides, the polyol will have the same number of terminal hydroxyl groups as the number of hydroxyl groups present in the compound from which it is derived.

Generally where one or more of X₁, X₂, X₃, X₄ and X₅ represents an OH-terminated polyoxyalkylene chain, in particular where 3, 4 or 5 of X₁, X₂, X₃, X₄ and X₅ represents an OH-terminated polyoxyalkylene chain, the polyol is maintained as a liquid at ambient temperature or temperatures slightly above (20 to 40° C.). Co-polymers of ethylene oxide with propylene oxide can be made which maintain flexibility at room temperature. Such a polyol preferably provides several advantages; in particular it is easier to handle and dispense at ambient temperature.

The polyol of formula I can be derived from various multi hydroxyl compounds e.g. a polyol comprising three polyoxyalkylene chains can be derived from the polymerization or copolymerization of ethylene or propylene oxides above or from a starter molecule of trimethylol propane, similarly a polyol comprising four polyoxyalkylene chains can be derived from pentaerythritol, and a polyol comprising five polyoxyalkylene chains can be derived from pentanepentols and/or sugar molecules bearing at least five hydroxyl groups.

According to one embodiment the Z group is trivalent, suitably the polyol is glycerol, trimethylpropane (TMP) or hexanetriol (HT), in particular 1,2,6-hexanetriol.

According to a further embodiment, the Z group is tetravalent, suitably the polyol is pentaerythritol.

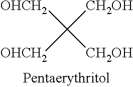

According to a further embodiment, when the Z group is pentavalent, suitably the polyol is pentanepentol (in particular 1,2,3,4,5-Pentanepentol), or is derived from pentanepentol (see formula II below).

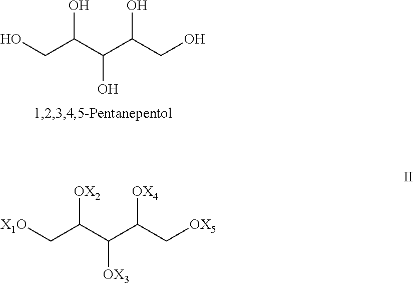

Where X₁, X₂, X₃, X₄ and X₅ independently represent H, or an optionally substituted OH terminated polyoxyalkylene chain.

In one preferred embodiment, the polyol is a macropolyol of formula Ia,

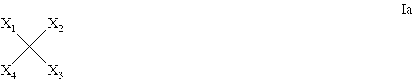

wherein each of X₁, X₂ and X₃ is independently a hydroxyl group or an optionally substituted OH terminated polyoxyalkylene chain;
and X₄ is H or as defined for X₁, X₂ and X₃.

In one preferred embodiment, the polyol is of formula Ia, each of X₁, X₂ and X₃ is independently an OH-terminated, unsubstituted polyoxyalkylene chain and X₄ is H.

Alternatively the polyol is of formula Ia, each of X₁, X₂ and X₃ is independently an OH-terminated, polyoxyalkylene chain and X₄ is H, where the polyoxyalkylene chain does not comprise any tertiary hydrogen atoms.

In another preferred embodiment, the polyol is of formula Ia, each of X₁, X₂ and X₃ and X₄ is independently an OH-terminated unsubstituted polyoxyalkylene chain, or alternatively an OH-terminated polyoxyalkylene chain where the polyoxyalkylene chain does not comprise any tertiary hydrogen atoms.

In another preferred embodiment, the macropolyol is of formula Ib,

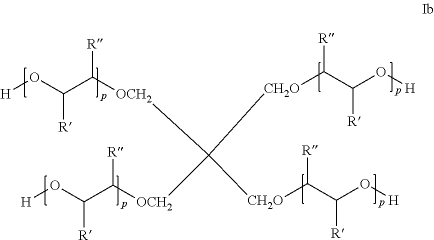

wherein each p is from about 3 to about 25 and R′ and R″ represent H. More preferably, p is about 25.

According to one embodiment the polyol is selected from the group consisting of trimethylolpropane (TMP), 1,2,6-hexanetriol (HT) and pentaerythritol (PER).

1,2,6-Hexanetriol (HT) is a clear, colourless viscous liquid at room temperature. HT acts as a 3D crosslinking agent. Increasing the concentration of HT in the reactant mixture, increases the modulus and reduces the water content of the resultant composition. Generally where the polyol is HT, the amount of polyol is 1 wt % or less, typically 0.2 to 0.7 wt %, generally 0.3 to 0.6 wt %.

Pentaerythritol is a white solid at room temperature. PER contains four hydroxyl groups and is used as covalent crosslinker to provide mechanical and thermal stability to the three dimensional polymer matrix of the resultant composition (e.g. a contact lens). Increasing the concentration of PER in the reactant mixture, increases the modulus and reduces the water content of the resultant composition. Generally where the polyol is PER, the amount of polyol is 1 wt % or less, typically 0.05 to 0.2 wt %, generally 0.05 to 0.1 wt %.

Trimethylolpropane (TMP) with its three primary alcohol groups is used as a three dimensional crosslinking agent. It is a white solid at room temperature and easily melts to give a clear liquid at temperatures above its melting range of 58-60° C. Increasing the amount of TMP present in the reactant mixture, increases the modulus and reduces the water content of the resultant composition. Generally where the polyol is TMP, the amount of polyol is 5 wt % or less, typically 0.5 to 3 wt %.

Preferably, the polyol or macropolyol is a fluid at ambient temperatures.

According to one embodiment, more than one polyol and/or more than one macropolyol may be used in the reactant mixture.

### Additional Compound

According to one embodiment, the reactant composition may include an additional compound comprising one or more hydroxyl groups and one or more primary or secondary amine groups. The additional compound may react with isocyanate groups to form urea, urethane and/or imine groups. The addition of such an additional compound in the reactant mixture provides the resultant composition with increased modulus and associated mechanical stability, through the formation of colloidal cross-links to the three dimensional hydrogel matrices. In addition, the use of the additional compound reduces the water content of the resultant composition and thus provides secondary controls for water content and the physical dimensions of an article formed from the composition of the present invention. The properties of the composition of the present invention may be controlled by using the appropriate amount of the additional compound.

Generally, the reactant mixture comprises from about 0.5 wt % or less of the additional compound, typically from about 0.01 to about 0.4 wt %, suitably from about 0.05% to about 0.2 wt %.

The additional compound is generally a difunctional amine, in which the double functionality is provided by the presence of one hydroxyl group and one primary or secondary amine group. According to one embodiment, the additional compound is ethanolamine (EA) (in particular 2-ethanolamine). 2-ethanolamine is a pungent, clear liquid at room temperature.

### Modulus Modifier

In one preferred embodiment of the invention, the composition further comprises one or more additional components such as a modulus modifier, plasticizer, humectant, lubricant, process aid, viscosity reducer, compatibility enhancer and/or polymer matrix structure modifier. Preferably, the additional component is present in an amount of 0 to about 20 wt %, more preferably from about 2.5 to about 10 wt %, more preferably still, about 2 to about 5 wt % of the reactants.

Suitable modulus modifiers include components that alter the modulus property of the polyurethane and may also alter the oxygen permeability property, suitably increasing the oxygen permeability of the resultant composition. Preferred modulus modifiers include a cycloalkyl modulus modifier (for example, as described in U.S. Pat. No. 4,327,203 incorporated herein by reference) or a polycyclic modulus modifier.

The modulus modifier has to be compatible such that it remains evenly distributed (i.e. homogeneous) and does not significantly alter the transmission properties and further, is non-toxic. Moreover, the modulus modifier should not generally react with the reactive components of the composition (i.e. PEG, PPG, di- or poly-isocyanate and polyol). If required, the modulus modifier may be extracted from the polymer composition following the polymerization reaction, for instance extracted out during the processing steps of lens manufacture. Suitable modulus modifiers include poly(ethylene glycol) dimethyl ether, PEG DME, PEG diethyl ether, PEG dipropyl ether, PEG dibutyl ether. Advantageously, it can be released slowly over a prolonged period of time to enhance lubricity of the surface in an aqueous environment (e.g. a contact lens on an eye). This in turn would provide significantly enhanced on-eye comfort.

Advantageously, the incorporation of a modulus modifier as an additive in the polymer compositions of the invention leads to lenses having a reduced modulus. Preferably, the modulus of lenses prepared from the polymer compositions of the invention is from about 0.1 to about 0.8 MPa, more preferably, about 0.3 to about 0.7 MPa, advantageously 0.4 to 0.5 MPa.

The cross-linking in a composition increases the structural integrity, improves the storage stability and also increases the modulus of the material. However, high modulus compositions are not preferred for use in the manufacture of contact lenses. Therefore, in such circumstances a modulus modifier suitably reduces the modulus of the composition. The concentration of the modulus modifier in a given composition can be adjusted to obtain the required modulus of the material, resulting in a medical device which is compatible for use in or on the body. In particular such a composition would provide a contact lens which is comfortable to wear.

The use of a modulus modifier may reduce the viscosity of the reactant mixture, and may also increase the working time associated with the reaction mixture by the small reduction of the concentration of the reactive groups. This is advantageous as it means that the reaction mixture can be dispensed in molds more easily than when using high viscosity compositions. The gelation time of the reaction mixture is also extended thereby allowing more time to dispense. The potential water content of resultant polymer compositions is also generally increased through the use of modulus modifiers particularly when a higher molecular weight PEG is used in a given composition.

### Additional Components

In one preferred embodiment, the composition further comprises one or more antioxidants. Suitable antioxidants include hindered phenols, BHA (butylated hydroxyl anisole), BHT (butylated hydroxytoluene) and ascorbic acid etc. Preferably, the antioxidant is BHA.

Preferably, the antioxidant is used in an amount of about 0.01 to about 3.0 wt % of the reactants, more preferably from about 0.02 to about 2.0 wt %, even more preferably from about 0.05 to about 1.0 wt %.

In one preferred embodiment, the composition of the invention further comprises one or more tinting agents. By way of example, suitable tinting agents commonly used in the contact lens industry include the following: benzene sulfonic acid, 4-(4,5-dihydro-4((2-methoxy-5-methyl-4-((2-(sulfooxy)ethyl)sulfonyl)phenyl)azo-3-methyl-5-oxo-1Hpyrazol-1-yl); [2-naphthalene-sulfonic acid, 7-(acetylamino)-4-hydroxyl-3-((4-((sulfo-oxyethyl)sulfonyl)phenyl)azo)-]; [5-((4,6-dichloro-1,3,5-triazin-2-yl)amino-4-hydroxy-3((1-sulfo-2-naphthalenyl)azo-2,7-naphthalene-disulfonic acid, trisodium salt]; [copper, 29H, 31H-phthalocyaninato(2-)-N₂₉,N₃₀,N₃₁,N₃₂)-,sulfo((4((2-sulfooxy)ethyl)sulfonyl)-phenyl)amino)sulfonyl derivative]; and [2,7-naphthalenesulfonic acid, 4-amino-5hydroxy-3,6-bis((4-((2-(sulfooxy)ethyl)sulfonyl)phenyl)azo)-tetrasodium salt].

Particularly preferred tinting agents for use in the present invention are phthalocyanine pigments such as phthalocyanine blue and phthalocyanine green, chromic-aluminacobaltous oxide, chromium oxides, and various iron oxides for red, yellow, brown and black colours, as well as others commonly used in the art. The use of organic pigments, particularly phthalocyanine pigments, more particularly copper phthalocyanine pigments, and even more particularly copper phthalocyanine blue pigment (e.g., Colour Index Pigment Blue 15, Constitution No. 74160) is preferred. Opaquing agents such as titanium dioxide may also be incorporated. For certain applications, a mixture of colours may be employed for better simulation of natural iris appearance.

In one preferred embodiment, the tinting agent is a handling tint such as Reactive Blue 4.

Preferably, the weight percentage of the tinting agent is from about 0.0001 wt % to about 0.08 wt % of the reactant mixture, more preferably, 0.0001 wt % to about 0.05 wt %. In one preferred embodiment, the tinting agent is present in an amount of from about 0.005 to 0.08 wt %. In one preferred embodiment, the weight percentage of the tint is from about 0.0001% to about 0.04%, more preferably, from about 0.0001% to about 0.03 wt % of the reactants. Optionally the tinting agent can be incorporated during the hydration stage.

In one preferred embodiment, the composition of the invention further comprises one or more UV blockers or UV absorbers. A UV absorber may be, for example, a strong UV absorber that exhibits relatively high absorption values in the UV-A range of about 320-380 nanometers, but is relatively transparent above about 380 nm. Preferably, the UV Blocker is a commercially available UV Blocker such as AEHB (acryloxyethoxy hydroxybenzophenone; C₁₈H₁₆O₅).

Generally speaking, a UV absorber, if present, is provided in an amount from about 0.5 wt % to about 1.5 wt % of the reactants. Particularly preferred are compositions which include from about 0.6 wt % to about 1.0 wt % UV absorber, more preferably, about 1.0 wt % of the reactants. Optionally the UV blocker may be incorporated during the hydration stage.

In one preferred embodiment, a catalyst is added to the mixture formed in step (i). In one preferred embodiment, the PEG, PPG, polyol, di- or poly-isocyanate and optionally the additional cross-linking compound are reacted in the presence of a catalyst. Preferably, the catalyst is a transition metal compound typically used for speeding up the reaction of isocyanates with hydroxyl-containing compounds and used in the manufacture of polyurethanes. Examples include, but are not limited to, transition metal catalysts such as tin, zinc, bismuth and zirconium catalysts. The catalyst may also be a tertiary amine or polyamine. Particularly preferred catalysts include dibutyl tin dilaurate (DBTDL), FeCl₃, stannous octoate, tertiary amines such as triethylamine, and the like. In one highly preferred embodiment, the catalyst is anhydrous Ferric chloride. Optionally mixed catalysts may be used.

Preferably, the catalyst is used in an amount of from about 0.02 wt % to about 1.0 wt % of the reactants, more preferably, from about 0.05 wt % to about 0.5 wt %, even more preferably, from about 0.05 wt % to about 0.2 wt %, of the reactants.

### Process

According to a second aspect of the present invention there is provided a process for preparing a polyurethane hydrogel, said process comprising:
i) preparing a mixture of:
A) at least one poly(ethylene glycol),
B) at least one polyoxyalkylene diol (typically PPG or a copolymer of ethylene oxide and propylene oxide),
C) at least one di- or poly-isocyanate,
D) at least one polyol or macropolyol having a functionality greater than 2, or a mixture of such polyols/macropolyols having a functionality of greater than 2,
E) optionally an additional compound comprising at least one hydroxyl group and at least one primary or secondary amine group;
ii) allowing the mixture formed in step i) to react appropriately to form a cross-linked polyurethane xerogel;
iii) hydrating the xerogel using an aqueous medium to form a hydrogel.

Preferably, the process of the present invention involves curing the reactant mixture of step i. directly to form a polyurethane xerogel without the need for the addition of water as a reactant. This is in contrast to the prior art process described in U.S. Pat. No. 6,930,196.

According to one embodiment, the reactant mixture is substantially anhydrous, i.e. without the addition of water as a reactant. The incorporation of urea groups (formed from the presence of water in the reactant mixture) increases the modulus value of the resultant polyurethane composition, which is undesirable in materials for use in the contact lens industry. Advantageously, the present invention substantially excludes water from the reactant mixture (as far as practically attainable), thereby minimising the formation of urea groups in the polymer backbone and giving rise to materials where contribution towards raising the modulus by urea groups is substantially minimised.

In order to minimise the formation of urea groups, where the additional component is or comprises an ethanolamine (EA), the amount of additional component is generally limited to no more than 0.1 wt %. Typically the amount of EA present is 0.01 to 0.05 wt %.

Suitable reactants for use in the process of the present invention are those described above.

In one preferred embodiment, a catalyst is added to the mixture formed in step (i). Suitable catalysts (together with guidance as to the appropriate amount) are as described above. In one highly preferred embodiment, the catalyst is ferric chloride (FeCl₃). Optionally mixed catalysts may be used.

Additional components, such as modulus modifiers, plasticizers, humectants, lubricants, antioxidants, process aids, viscosity reducers, tinting agents, compatibility enhancers and/or polymer matrix structure modifiers as described above, may also be present in the reaction mixture.

In one preferred embodiment of the invention the reactants in step (i) are mixed and dehydrated under vacuum. Preferably, the reactants are dehydrated under vacuum at a temperature of about 95° C. for at least 90 minutes. Generally, the reactants are dehydrated (typically under vacuum) until the moisture content of the mixture is reduced to a level below 0.05 wt %.

In one preferred embodiment, the di- or poly-isocyanate is added to a mixture of the PEG, the PPG and optionally the polyol.

Preferably, the reactants in step (i) are degassed under vacuum using a rotary evaporator.

The xerogel may be hydrated using an aqueous medium with or without a surfactant.

A further aspect relates to a polymer obtainable by the process of the invention.

Yet another aspect relates to the use of a polymer according to the invention in the preparation of a contact lens.

### Process for Preparing a Contact Lens

A further aspect of the present invention relates to a process for preparing a contact lens comprising the steps of:
i) preparing a mixture of:
   a. at least one poly(ethylene glycol),
   b. at least one polyoxyalkylene diol (typically PPG or a copolymer of ethylene oxide and propylene oxide),
   c. at least one di- or poly-isocyanate, and
   d. at least one polyol or macropolyol, said macropolyol having a functionality greater than 2, or a mixture of such polyols/macropolyols having a functionality of greater than 2, and
   e. optionally an additional compound comprising at least one hydroxyl group and at least one primary or secondary amine group;
ii) dispensing the reaction mixture formed in step i) into a contact lens mold;
iii) allowing the reaction mixture to react and cure (generally with the assistance with energy, in particular thermal energy or other means of radiation);
iv) removing the contact lens from the mold; and hydrating the contact lens, in an aqueous fluid, optionally comprising a non-ionic surface active agent, such as a polysorbate or poloxamer compound or mixture thereof.

Generally the reaction mixture must be dispensed in molten form at temperatures of from 50 to 70° C. as the reaction mixture is generally not liquid at ambient temperature.

In one preferred embodiment, the reactants in step (i) are dispensed into a female lens mold and the male part of the lens mold is then placed over the liquid contained in the female part and subsequently closed, typically by a machine or other means.

In one preferred embodiment, the molds are placed in an oven and allowed to cure to complete the reaction. Preferably, the molds are allowed to cure at a temperature of from about 70° C. to about 100° C., more preferably, from about 85° C. to about 95° C. In one highly preferred embodiment, the molds are allowed to cure at a temperature of least 95° C.

Preferably, the molds are allowed to cure for about 0.5 to about 24 hours, more preferably for about 15 to 22 hours. Alternatively, the molds may be allowed to cure for about 3 to about 8 hours, typically for at least about 5 hours. Optionally the curing can also be done in the oven under a dry nitrogen flow.

Preferably, the molds are removed from the oven and allowed to cool to around ambient temperature, and then may be demolded.

Optionally, after step (iii) the mold may be cooled to a temperature of from about −30° C. to about −120° C. prior to removing the contact lens from the mold.

Suitably, the molds are chilled in a freezer. More preferably, still, the molds are chilled to a temperature of from about −50° C. to about −90° C., even more preferably from about −60° C. to about −90° C. More preferably still, the molds are chilled to a temperature of about −80° C. Preferably, the molds are chilled for about 30 minutes, more preferably, at about 60 minutes. In one especially preferred embodiment, the lenses are chilled for at least 20 minutes.

Advantageously, the cooling process allows the polymer chains to attain a temperature below the glass transition temperature that shrinks the polymer matrix and reduces the interaction at the interface which enhances the demolding of the lens product.

The lenses are then preferably demolded from the molds by separating the male and female parts. Preferably, the lenses are hydrated by immersion in a hydration solution. Typically the hydration solution comprises saline solution which may optionally comprise surfactant. According to one embodiment the hydration solution comprises a non-ionic surface active agent, such as a polysorbate or poloxamer compound. In particular, the hydration solution comprises polysorbate 20.

Alternatively, in another preferred embodiment where a modulus modifier has been used in the formulation, the lens molds are physically separated (at ambient temperature) and the part containing the lense immersed in excess of saline solution (optionally comprising surfactant) for 5-150 minutes, more preferably for 60-90 minutes, more preferably still for 30-60 minutes, to demold the lens.

Generally, processing step (ii) involves reaction cast molding where the material is molded into the shape of a lens. This process is generally referred to as reaction cast moulding (RCM), and the lens produced by this method is termed here as an RCM lens.

The polymeric composition of the present invention is covalently cross-linked and, once polymerised, will not melt or flow without chemical decomposition.

Advantageously, the polymeric composition of the present invention, or an article of manufacture formed therefrom, is able to withstand autoclave steam sterilisation without significant permanent distortion of its dimensions when returned to ambient temperature.

Steam sterilisation generally takes place under increased temperature and pressure. Typically temperatures of 100 to 150° C. are used. Pressures of 160 to 165 kPa are commonly used.

### Article of Manufacture

Another aspect of the invention relates to an article of manufacture comprising a polymer as described above.

According to one aspect of the present invention, there is provided a polymer obtainable by any of the above described processes.

Preferably, the article of manufacture is in the form of a medical device. The polyurethane composition is typically in the form of a medical device for use in or on the body. The medical device may be exemplified by, but by no means limited to, urinary tract devices (including urethral stents and urinary catheters), ocular devices (including contact lenses and intra-ocular shooters), intraocular lenses, orthopaedic devices, respiratory devices (including endotracheal tubes), cardiovascular devices, dental devices, neurological devices, gastrointestinal devices, audio logy devices, surgical devices, including surgical gloves, foot care devices, wound healing devices, condoms and the like apheresis equipment, blood bags; blood administration tubing; extracorporeal membrane oxygenation equipment; dialysis and peritoneal drainage bags; urinary collection bags; urological catheters; wound drainage bags and tubes; enteral feeding equipment; nasogastric tubes; intravenous catheters, drip chambers, tubing and solution bags; total parenteral nutrition bags; haemodialysis tubing and catheters; film wrap; gloves; endotrachael tubes; tracheotomy tubes; oesophageal tubes; humidifiers; ocular prosthesis; or sterile water bags and tubing.

According to one embodiment the medical devices is a lens, such as a contact lens, a catheter, or an intra-ocular shooter.

Preferably the article of manufacture is in the form of a contact lens.

A contact lens must be permeable to oxygen in order for the lens to facilitate normal corneal metabolism. Preferably, contact lenses prepared using the polymer composition of the invention exhibit a DK value of a least 10 Barrer, preferably, at least 20, more preferably, about 30 Barrer, even more preferably about 40 Barrer.

In one preferred embodiment, the lenses have a DK of about 15 to about 45 Barrer more preferably, from about 25 to about 40 or more Barrer.

A contact lens must be able to transmit light in the visible region in order to function effectively in correcting visual defects. Preferably, contact lenses prepared using the polymer composition of the invention exhibit a light transmissibility of at least 80%, more preferably at least 90%, even more preferably, at least 95% or 97%. Preferably, the light transmissibility is from about 90 to about 100%, more preferably from about 95 to about 100%, more preferably still, 100%.

Preferably, contact lenses produced using the polymer composition of the invention exhibit a modulus of from about 0.1 to about 1.25 MPa, typically from about 0.25 to about 0.75 MPa, generally from about 0.30 to about 0.5 MPa.

The modulus of a contact lens plays a key role in controlling the mechanical properties of a soft contact lens. In addition, the on-eye performance is directly affected by the modulus. A value of greater than 1.25 MPa is likely to cause corneal staining whilst a modulus below 0.1 MPa is likely to lead to a lens with poor handling properties.

Preferably, contact lenses produced using the polymer composition of the invention have a water content of 10 to about 90 weight %, more preferably, from about 20 to about 80 weight %, more preferably, from about 25 to about 75 weight %, even more preferably, from about 30 to about 70 weight %, more preferably still, from about 40 to about 70 weight %.

The equilibrium water content of the lens is an important the material attribute and plays a key role in determining the bulk, mechanical and physical properties of the lens. Water and the polyoxyethylene chains provide the medium to transmit oxygen and with the modulus governs the on-eye properties of the lens.

Generally the polyurethane composition of the present invention has a very high visual clarity, with little or no associated light scattering. Lenses formed from the polyurethane composition of the present invention do not generally exhibit any Tyndall effect.

The present invention will now be described by way of non-limiting example only with reference to accompanying tables 1, 2 and 3 illustrating embodiments of the present invention.

### EXAMPLES

### Materials & Treatment

Poly(ethylene glycol) 6000 (two different batches), 3500 and 8000 (ex Clariant) were separately dehydrated under vacuum. The duration and conditions of dehydration depends upon the sample weight and is adjusted such that the residual moisture content falls below 0.05 wt %. For the articles formed according to the Examples, the materials were generally dehydrated at 95° C. for 4 hours. The number average molecular weights (Mn) of the materials were determined by the end group analysis. These analyses respectively afforded Mn=5527 & 5931 (of a different batch of PEG 6000), 3880 and 8095. These values were used in calculating the stoichiometry and the material so formed is referred in the tables of the examples as PEG 5527, PEG 5931. PEG 3880, PEG 8095. Subsequently the dehydrated materials were used in the manufacture of polymer/lenses.

Poly(propylene glycol) of molecular weight 430 (ex Atlas polymers), referred herein after as PPG 430, was also dehydrated under vacuum at 95° C. using a rotary evaporator to reduce the moisture content to <0.030% before use. Dcyclohexylmethane-4,4′-diisocyanate, Desmodur W, was also sourced from Atlas Polymers UK and used without further purification. Ethanol amine (EA), ferric chloride (anhydrous), hexane triol (HT), trimethylol propane (TMP), and butylated hydroxyanisole (BHA) were sourced from Sigma Aldrich and used as supplied.

### Method of Manufacture

The compositions detailed in Tables 1.2 were manufactured by a common method described below for composition 1 listed in the Table 1.

Using an analytical balance accurately weigh, into a 100 ml round bottom quickfit flask, the appropriate quantities of dehydrated PPG 430 (7.3398 g), HT (0.9136 g), Ferric chloride (0.0167 g), BHA (0.0182 g) the flask is stoppered and placed in a microwave for few seconds to dissolve the contents. EA (0.0204 g) and the dehydrated PEG 5527 (20.021 g) were then added to the flask. (Optionally the above components can be mixed together and then subjected to the necessary dehydration.) The contents were mixed using a magnetic stirring rod and DesmodurW (8.3500 g) was added to the flask through a syringe. The stirring was continued for one more minute and the flask was attached to a rotary evaporator to degas. This material was then dispensed into the female part of the preheated polypropylene lens moulds, the male part of the moulds were carefully touch dropped and subsequently dosed by using a machine or other method. These moulds were then cured for 22 hours in an oven at 95° C. to complete the reaction. The lens moulds containing the product were allowed to cool to ambient temperature, chilled in a freezer, separated, the products (contact lenses) were demolded. These lenses were subsequently immersed individually into saline contained in glass vials. After ˜2 hours of hydration these were steam sterilised (122° C. for 20 minutes) using a standard autoclave and method.

Optionally the saline may contain tinting agent such as Reactive Blue 4.

### Water Content

Water content is calculated by determining dry weight and hydrated weight of a lens according to the following equation:

Water Content(%)=(W_{hydrated lens}−W_{dry lens})/W_{hydrated lens}[×100]

Five hydrated lenses, with excess surface water removed, are separately weighed on an analytical balance. The lenses are then dried in an oven at 75° C. for 2 hours and weighed again separately. The water content of each lens was determined separately using the above equation. Finally an average value for the water content of the lenses was determined, and the average value represents the water content of that lens composition.

### % Transmittance

% Transmittance was determined under the guidance of ISO 8599 by using a double beam UV spectrophotometer (Jasco V530). A lens is placed into a cuvette containing standard saline solution. The cuvette is placed in the sample compartment. A matching cuvette containing saline is placed in the reference compartment of the UV spectrophotometer and a spectrum as percent transmittance was recorded between 200-780 nm. The test was repeated a further four times and the mean value (% transmittance) at 550 nm was recorded. The lenses of the present invention afforded light transmission in excess of 80% at 550 nm.

### DK Measurement

DK Measurement (i.e., oxygen permeability) was carried out by the polarographic technique as briefly described below:

Ten lenses were placed into the Gallenkamp incubator set at 35+/−0.5° C. for 24 hours. The centre thickness (CT) of each of the ten lenses were measured by Rehder ET-3 Electronic Thickness Gauge and these lenses were stacked as follows: A single lens stack, two lens stack, three lens stack, and four lens stack. The CT of each stack was measured three times and a mean value for each was calculated and fed into a spread sheet specifically developed for the method. Also recorded was the atmospheric pressure. The stack of lenses were replaced into the incubator set at 35+/−0.5° C. and humidity >98%.

Each stack was separately placed on to the electrode (Rehder Permeometer with 8.7 mm electrode) ensuring that there are no bubbles entrapped between the lenses and the electrode. When the current reached its lowest point the reading was recorded in the relevant section of the spread sheet. This test was repeated for all the stacks.

The dark current reading (background) of the measurement system, when no oxygen is able to pass through to the electrode, was recorded and subtracted from all test material current values. Data was analysed taking into consideration the partial pressure of oxygen and the surface area of the polarographic sensor used and finally corrected for the edge effect. A graph of DK/t corr versus thickness (cm) was then plotted and the inverse of the gradient of the best fit taken to represent the oxygen permeability (DK) of the lens material.

### Modulus Data

Modulus data was measured for contact lenses prepared in accordance with the invention by tensile testing using the instron 5842 Tensile testing system with Merlin Software.

Correlation to Standards/Regulation: ISO 9001:2008 (Quality Standards: Par 7.6; ISO 13485:2003 Medical Device Directive: Par 7.6; FDA Part 820 QS Regulation Subpart G: Control of inspection, monitoring and test equipment 820.72.

### Process (Material Preparation)

Thickness readings for each lens were obtained using the ET-3 Thickness gauge. The lenses were placed flat on the cutting mat and two long pieces were cut from around the centre of the flat lens using a razor blade. These cut pieces were put into saline solution in a sample dish. The sample was loaded on to clamps using tweezers carefully going for the top clamp first and then the bottom. The gap in between the clamps was set at 10 mm using a calibrated vernier caliper. Once set, the “Reset GL” button was pressed to set the Gauge Length”. Once the sample was loaded, the balance load was set to 0.000N and the test was started using the console controls.

### Contact Angle

The contact lenses to be tested were prepared by removing them from the surfactant solution in which they are generally stored, and washing them with water. Each lens was removed from packaging and dried using tissue. Six lenses of each lens type were placed into a jar containing at least 500 mls of deionised water (DI water). Each jar was then stored at 25° C. for 16 hours or more. The DI water was then replaced and each jar was placed onto a roller unit for 2 hours. The lenses were then taken out of the jars and placed separately into labelled vials containing fresh DI water.

The wet lenses were removed from the jar using silicone tipped tweezers. Excess saline was removed by placing the lens front surface down onto a lint free tissue. The lens was then placed so that the convex surface was facing upwards, and a test sample was cut using the 4 mm cutter. The cut lens section was then placed face down on the lens wipe and the surface liquid was allowed to blot. The section was placed onto a microscope slide with front of the lens facing upwards and the section lying flat. The microscope slide was then placed underneath the PGX within the camera zone. “Pump” was pressed on the PGX, until a droplet emerges, this droplet then falls onto the section surface of the cut lens strip. The software measures the contact angle as soon as the drop touches the surface.

Table 1 shows some examples of the compositions of the present invention. The molecular weight of the PEG used in the compositions was varied. Compositions containing the polyol HT, and compositions containing the polyol TMP are exemplified in Table 1.

Table 2 shows some examples of the compositions of the present Invention. The compositions of Table 2 contained PEG having a molecular weight of around 6000. The compositions exemplified in Table 2 contain the polyol TMP.

The symbols V1, V2, V3 and V5D indicated in the Table headings are internal references used by the applicant, and are used for the convenience of the inventors.

Various modifications and variations of the described aspects of the invention will be apparent to those skilled in the art without departing from the scope and spirit of the invention. Although the invention has been described in connection with specific preferred embodiments, it should be understood that the invention as claimed should not be unduly limited to such specific embodiments. Where provided, numerical values are intended to include a range of 10% either side of the value given. Various modifications of the described modes of carrying out the invention which are obvious to those skilled in the relevant fields are intended to be within the scope of the following claims.

1. A polyurethane polymer composition prepared by reacting a mixture comprising:
a) at least one poly(ethylene glycol),
b) at least one polyoxyalkylene diol,
c) at least one di- or poly-isocyanate,
d) at least one polyol or macropolyol having a functionality greater than 2, or a mixture of such polyols or macropolyols having a functionality greater than 2, and
e) optionally an additional compound comprising at least one hydroxyl group and at least one primary or secondary amine group.

2. The polymer composition as claimed in claim 1 wherein the poly(ethylene glycol) has a molecular weight of 3000 to 9000.

3. The polymer composition as claimed in claim 1 wherein the polyoxyalkylene diol is PPG or a hydroxyl terminated copolymer of ethylene oxide and propylene oxide having a molecular weight of 300 to 800.

4. The polymer composition as claimed in claim 1 comprising at least one di-isocyanate selected from the group consisting of methylene dicyclohexyl diisocyanate, isophorone diisocyanate, toluene-2,4-diisocyanate, toluene-2,6-diisocyanate, mixtures of toluene-2,4 and 2,6-diisocyanates, ethylene diisocyanate, propylene-1,2-diisocyanate, cyclohexylene-1,2-diisocyanate, cyclohexylene-1,4-diisocyanate, m-phenylene diisocyanate, 4,4″-biphenylene diisocyanate, 3,3″-dichloro4,4″-biphenylene diisocyanate, 1,6-hexamethylene diisocyanate, 1,4-tetramethylene diisocyanate, 1,10-decamethylene diisocyanate, cumene-2,4-diisocyanate, 1,5-napthalene diisocyanate, 1,4-cyclohexylene diisocyanate, 2,5-fluorenediisocyanate and polymeric 4,4′diphenylmethane diisocyanate methylene dicyclohexyl diisocyanate and mixtures thereof.

5. The polymer composition as claimed in claim 1 comprising at least one poly-isocyanate selected from the group consisting of tri-functional trimer (isocyanurate) of isophorone diisocyanate, trifunctional trimer (isocyanurate) of hexamethylene diisocyanate and polymeric 4,4′-diphenylmethane diisocyanate.

6. The polymer composition as claimed claim 1 wherein the polyol or macropolyol has the structure of formula I: 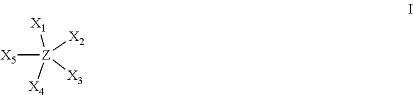
wherein at least three of X₁, X₂, X₃, X₄ and X₅ are each independently a hydroxyl terminated polyoxyalkylene chain, the remainder of X₁, X₂, X₃, X₄ and X₅ are each independently H or absent, and Z is a central linking unit.

7. The polymer composition as claimed in claim 6 wherein Z represents a hydrocarbyl group, optionally comprising one or more trisubstituted nitrogen, ether, ester and tertiary amine groups.

8. The polymer composition as claimed in claim 1 wherein the polyol is glycerol, trimethylpropane (TMP) or hexanetriol (HT).

9. The polymer composition as claimed in claim 1 wherein the macropolyol has the structure of formula 1a or 1b: 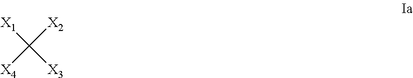
wherein each of X₁, X₂ and X₃ is independently an optionally substituted OH terminated polyoxyalkylene chain;
and X₄ is H or as defined for X₁, X₂ and X₃; 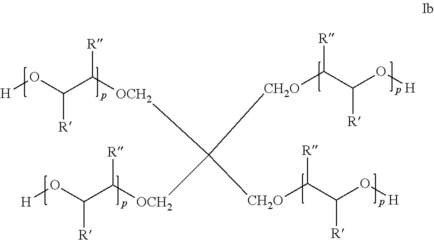
wherein each p is from about 3 to about 25 and R′ and R″ represent H.

10-11. (canceled)

12. The polymer composition as claimed in claim 1 wherein the mixture is essentially anhydrous.

13. The polymer composition as claimed in claim 1 comprising the additional compound, wherein said additional compound is a difunctional amine comprising one hydroxyl group and one primary or secondary amine group.

14. A contact lens formed from the polymer composition of claim 1.

15. A process for preparing a polyurethane hydrogel, said process comprising:
i) preparing a mixture of:
a) at least one poly(ethylene glycol),
b) at least one polyoxyalkylene diol,
c) at least one di- or poly-isocyanate,
d) at least one polyol or macropolyol having a functionality greater than 2, and
e) optionally an additional compound;
ii) allowing the mixture formed in step i) to react appropriately to form a cross-linked polyurethane xerogel; and
iii) hydrating the xerogel using an aqueous medium to form a hydrogel.

16. A polymer obtained or obtainable by the process of claim 15.

17. A process for preparing a contact lens comprising the steps of:
i) preparing a mixture of:
a. at least one poly(ethylene glycol),
b. at least one polyoxyalkylene diol,
c. at least one di- or poly-isocyanate,
d. at least one polyol or macropolyol, said macropolyol having a functionality greater than 2 or a mixture of such polyols or macropolyols having a functionality greater than 2, and
e. optionally an additional compound comprising at least one hydroxyl group and at least one primary or secondary amine group;
ii) dispensing the reaction mixture formed in step i) into a contact lens mold;
iii) allowing the reaction mixture to react and cure (generally with the assistance with energy, in particular thermal energy or radiation);
iv) removing the contact lens from the mold; and
v) hydrating the contact lens, optionally in an aqueous fluid comprising a non-ionic surface active agent, preferably a polyoxamer or a polysorbate compound or mixture thereof.

18. An article of manufacture comprising a polymer composition as claimed in claim 1.

19. The article of manufacture as claimed in claim 18 in the form of a medical device selected from the group consisting of urinary tract devices (including urethral stents and urinary catheters), ocular devices (including contact lenses and intra-ocular shooters), intraocular lenses, orthopaedic devices, respiratory devices (including endotracheal tubes), cardiovascular devices, dental devices, neurological devices, gastrointestinal devices, audio logy devices, surgical devices, including surgical gloves, foot care devices, wound healing devices, condoms and the like apheresis equipment, blood bags; blood administration tubing; extracorporeal membrane oxygenation equipment; dialysis and peritoneal drainage bags; urinary collection bags; urological catheters; wound drainage bags and tubes; enteral feeding equipment; nasogastric tubes; intravenous catheters, drip chambers, tubing and solution bags; total parenteral nutrition bags; haemodialysis tubing and catheters; film wrap; gloves; endotrachael tubes; tracheotomy tubes; oesophageal tubes; humidifiers; ocular prosthesis and sterile water bags and tubing.

20. The article of manufacture as claimed in claim 19 in the form of a lens, a catheter, or an intra-ocular shooter.

21. The article of manufacture as claimed in claim 20 wherein the lens is a contact lens.

22. The article of manufacture as claimed in claim 18, wherein said article does not undergo permanent distortion of its dimensions after being subjected to autoclave steam sterilisation.

23-26. (canceled)
